(19) United States
(12) Patent Application Publication
(10) Pub. No.: US 2007/0015103 A1
(43) Pub. Date: Jan. 18, 2007

(54) LINGUAL BRACKET

(75) Inventor: Olivier Sorel, Rennes (FR)

Correspondence Address: LEYDIG VOIT & MAYER, LTD, 700 THIRTEENTH ST. NW, SUITE 300, WASHINGTON, DC, 20005-3960, US

(73) Assignee: DENTAURUM J. P. WINKELSTROETER KG, Ispringen (DE)

(21) Appl. No.: 11/465,533

(22) Filed: Aug. 18, 2006

Related U.S. Application Data
(63) Continuation of application No. PCT/EP05/01713, filed on Feb. 18, 2005.

(30) Foreign Application Priority Data
Feb. 20, 2004 (DE) 10 2004 009 916.2

(51) Int. Cl. A61C 3/00

(52) U.S. Cl. 433/8

(57) ABSTRACT

The invention relates to a lingual bracket for correcting the position of teeth, comprising a bracket base, which can be secured on the lingual side to a front or canine tooth, and comprising a bracket body, the bracket having a slot, which extends in the mesial-distal direction, delimited on the lingual side as well as on the gingival and occlusal sides, and which is intended for accommodating an archwire. In order to develop the bracket in such a way that an archwire can be easily inserted into the slot, by which even relatively small directional forces may be reproducibly exerted on the tooth and the risk of root resorption can be kept low, the slot is delimited on the gingival side by the bracket base and on the occlusal and lingual sides by the bracket body. Furthermore, a bracket system comprising a front or canine tooth bracket of this type and comprising a side tooth bracket is provided.

### CROSS-REFERENCE TO RELATED APPLICATIONS

This application is a continuation of international application number PCT/EP2005/001713 filed on Feb. 18, 2005.

The present disclosure relates to the subject matter disclosed in international application number PCT/EP2005/001713 of Feb. 18, 2005 and German application number 10 2004 009 916.2 of Feb. 20, 2004, which are incorporated herein by reference in their entirety and for all purposes.

### BACKGROUND OF THE INVENTION

The invention relates to a lingual bracket for correcting the position of teeth, comprising a bracket base, which can be secured on the lingual side to a front or canine tooth, and comprising a bracket body, which protrudes from the bracket base, the bracket having a slot, which extends in the mesial-distal direction, is delimited on the lingual side as well as on the gingival and occlusal sides, and which is intended for accommodating an archwire.

In order to correct positions of misaligned teeth in orthodontic treatment, it is known to secure brackets to the teeth, the brackets being connected to one another by an elastic archwire placed in the respective slot in the brackets. The archwire can be used to exert directional forces on the teeth, so that the position of the tooth changes. In this way, forces of angulation, rotation and torsion are exerted on the teeth to correct the misalignment. A laterally inclined position of the teeth can be corrected by means of forces of angulation, forces of rotation have the effect of turning the tooth about its longitudinal axis and forces of torsion pivot the tooth transversely in relation to the row of teeth, that is to say about an axis which extends transversely in relation to the longitudinal axis of the tooth and approximately parallel to the row of teeth.

The brackets may be secured on the labial or lingual side, that is to say toward the lips or toward the mouth cavity. Securement on the lingual side has the advantage that the brackets and the archwire cannot be seen behind the teeth. For adult patients in particular, this is very important. However, exact positioning of the brackets on the lingual side is much more difficult for the orthodontist than positioning of the brackets on the labial side. It has therefore been proposed in EP 1 234 549 A1 to align the slot obliquely in relation to the occlusal plane, so that the archwire can be inserted into the slot from the occlusal side without the aid of a mirror. The occlusal plane is understood here as meaning the horizontal plane between the teeth of the upper jaw and the teeth of the lower jaw. In the case of the bracket for the front and canine teeth that is known from EP 1 234 549 A1, it is necessary to fix the archwire in the obliquely aligned slot, by covering the slot from the occlusal side by means of a closure spring to transfer forces from the archwire to the bracket. If forces of torsion are to be transferred from the archwire to the tooth, a torque directed about the longitudinal axis of the wire is exerted on the brackets, and opposite closing forces have to be exerted by the closure spring ill order to hold the archwire reliably in the slot. As a result, the reproducible exertion of forces of torsion on the tooth is made more difficult, since in many cases the closing forces of the closure spring are not constant over time.

A further bracket which can be secured on the labial side of a tooth is known from EP 1 080 697 A1. The bracket has a bracket base, which can be secured to the tooth, and an elongated bracket body, which protrudes from the bracket base in the lingual direction and in which a slot for accommodating the archwire is formed. Turning away from the customary “mushroom shape”, the archwire is to have the form of a simple arch, without great curvatures. The bracket body therefore reaches relatively deep into the mouth cavity, and relatively great torques are exerted on the tooth via the bracket body by the archwire inserted into the slot. However, the exertion of relatively great torques can lead to root resorption. Furthermore, the considerable lever action of the bracket body has the effect that the reproducible exertion of in particular relatively small directional forces is made more difficult, and the great extent to which the bracket projects is extremely unpleasant for the patient.

It is an object of the present invention to provide a lingual bracket of the type mentioned at the beginning in the case of which the archwire can be easily inserted into the slot, by which even relatively small directional forces may be reproducibly exerted on the tooth and the risk of root resorption can be kept low, accompanied at the same time by a high level of comfort for the patient.

### BRIEF SUMMARY OF THE INVENTION

This object is achieved according to the invention in the case of a lingual bracket of the generic type by the slot being delimited on the gingival side by the bracket base and on the occlusal and lingual sides by the bracket body.

The insertion of the archwire into the slot of the bracket according to the invention can be directly observed by the orthodontist, without having to use a mirror. This is so because, for insertion, the archwire can firstly be positioned from the occlusal side to the height of an opening of the slot and the archwire can subsequently be displaced in the horizontal direction, i.e. parallel to the occlusal plane, in the direction of the mouth cavity until it lies against a slot base. The archwire is then enclosed by the bracket not only in the occlusal and gingival directions but also in the lingual direction. The delimitation of the slot in the occlusal and lingual directions takes place by the bracket body, and the delimitation in the gingival direction takes place by the bracket base. The archwire, inserted into the slot, consequently lies directly against the bracket base and is therefore only a small distance away from the tooth. This makes a more controlled and more reproducible transfer even of small directional forces possible from the archwire via the bracket to the tooth. In particular, forces of torsion and angulation can easily be reproducibly exerted, and the risk of root resorption is very low.

The slot is covered, inter alia, on the lingual side. This also has the advantage that the patient's tongue is irritated far less by the bracket than in the case of an opening of the slot on the lingual side.

The slot comprises a slot base and two slot walls which protrude from the latter and delimit a slot opening between them at a distance from the slot base. It is of advantage if the slot walls are aligned horizontally when the bracket is in its position of use. This makes a cross-sectionally rectangular configuration of the slot possible, the slot walls being aligned parallel to the occlusal plane. It has been found that particularly easy control, in particular of the forces of torsion and angulation, is made possible as a result.

The bracket body preferably has a web which protrudes from the bracket base in the occlusal direction and carries at its free end a wing pointing in the labial direction, the web and the wing delimiting the slot on the lingual and occlusal sides, respectively, and the bracket base delimiting the slot on the gingival side. The slot consequently extends between the bracket base and the wing of the bracket body, the rear side of the bracket base that is turned away from the tooth and the side of the wing that is directed toward the bracket base respectively defining a slot wall, and the slot base being formed by the web.

In the case of an advantageous embodiment of the bracket according to the invention, the slot opening is adjoined, away from the slot base, by an insertion portion, which is delimited on the one hand by the bracket base and on the other hand by the bracket body. This makes the insertion of the archwire even easier. The insertion portion allows the archwire to be positioned from the occlusal side to the height of the slot opening, and the archwire can subsequently be inserted into the slot in a horizontal direction. The insertion portion is delimited in the gingival direction by the bracket base and in the occlusal direction by a region of the bracket body adjoining the slot.

The insertion portion is preferably delimited by a front side of the wing directed away from the web and by a rear side of the bracket base.

The insertion portion preferably widens in the direction away from the slot base. This makes it possible for the archwire to be guided within the insertion portion, which opens into the slot opening.

It is advantageous if the bracket has a smooth, uninterrupted surface on the lingual side, in particular is convexly or concavely curved on the lingual side, since irritations of the tongue can be kept very low and the patient can become accustomed to the bracket within a short time as a result.

In the case of an advantageous embodiment of the bracket according to the invention, the bracket body has a small hook on its side away from the slot. Additional bracing elements can be easily secured to the small hook. It is in this case less irritating for the patient if the small hook is integrated in the lingual side of the bracket body. This allows the entire lingual side of the bracket to be given a rounded and smooth configuration that is pleasant for the patient.

It may be provided, for example, that the bracket body has two wings, which protrude in opposite directions from a web connected to the bracket base. A first, labially aligned wing may delimit the slot in the occlusal direction, and the second, substantially lingually aligned wing may carry at its free end the small hook, which may be of a T-shaped form.

In the transitional region between the canine tooth and the premolar, the archwire is to be aligned in the direction of the mouth cavity on account of the different size of the two teeth. If these two teeth are close together, there is only very little space available for the archwire. This has the consequence that in many cases a ligature cannot be applied to the archwire in this region at the beginning of orthodontic treatment. This in turn protracts the treatment time. In order to counteract protraction of the treatment in this way, in the case of a particularly preferred embodiment of the bracket according to the invention for canine teeth it is provided that the distal edge of a region of the bracket body delimiting the slot on the occlusal side is inclined in the direction of the mesial edge of the bracket. In the approximal region of the premolar, the region of the bracket body covering the slot on the occlusal side is consequently set back slightly. This makes early ligation of the archwire possible, even when the canine tooth and premolar are close together. The treatment time can be reduced as a result.

It is of particular advantage if, for adaptation to the shape of the tooth, the bracket base has, for butting against a tooth, abutting surface regions that are anatomically aligned at an angle in relation to one another. This makes it possible for the bracket to be secured very close to the gingiva, and consequently very close to the center of resistance of the tooth. Consequently, increased control can be achieved, in particular of forces of torsion. Furthermore, it has been found that angling the abutting surface regions away is more likely to allow a uniform torque angle to be used for the brackets of the front and canine teeth.

In the case of a preferred embodiment, a first abutting surface region of the bracket base is inclined at an angle of approximately 100 to about 500 in relation to a second abutting surface region of the bracket base.

The abutting surface regions are preferably in each case of a planar configuration. Alternatively, it may be provided that at least one abutting surface region is curved, in particular the abutting surface regions may altogether form a convexly curved abutting surface of the bracket base.

The invention also relates to a bracket system for fixing an archwire on the lingual sides of teeth, at least one side tooth bracket, comprising a bracket base, which can be fixed on the lingual side to a side tooth, and comprising a bracket body, which protrudes from the bracket base, also being used in addition to the lingual brackets for front and canine teeth explained above, the side tooth bracket having a slot, which extends in the mesial-distal direction and is intended for accommodating the archwire, comprising a slot base and two slot walls which protrude from the base and delimit the slot on the gingival side as well as on the labial and lingual sides, and the archwire being insertable into the slot from the occlusal side.

The placement of the archwire in the side tooth bracket is very easy in the case of such a configuration, since the archwire can be inserted directly into the slot from the occlusal side. While in the case of the bracket for the front and canine teeth explained above, the slot is preferably horizontally aligned in the position of use of the bracket, a bracket with occlusal alignment of the slot is used in the case of the bracket system according to the invention for the side teeth. The combination of horizontal and occlusal alignment of the slots in the case of such a bracket system has the advantage that the position of the archwire in the slots is better defined. The front and canine teeth brackets fix the archwire in the occlusal-gingival direction and the side tooth brackets fix the archwire in the lingual-labial direction. Although a ligature that is known per se, and is therefore not explained in any more detail here, is used in the customary way in the case of the bracket system according to the invention, this substantially serves merely for securing the archwire during the orthodontic treatment, but force can be transferred from the archwire to the brackets substantially without any ligature in between, at least in the region of the front and canine teeth, and the position of the archwire in the slots is very well defined by the alignment of the slots of the front and canine teeth brackets on the one hand and the slots of the side tooth brackets on the other hand, turned by 90° in relation to one another.

The slot of the side tooth bracket has a slot base and two slot walls protruding from the latter. It is advantageous here if the slot walls are vertically aligned in the position of use of the side tooth bracket. Compared with the slot walls of a preferred embodiment of the brackets for the front and canine teeth, the slot walls of the side tooth bracket are consequently turned by 90°. This has the advantage that the height of the side tooth brackets on the lingual side can be kept very low, since the longer side of the slots extends substantially parallel to the bracket base. The placement of the archwire can be observed well from the occlusal side.

Round or cross-sectionally square archwires are used for the bracket system according to the invention. Given the same diameter of round wires or the same side length of square wires, such as the same shorter side length of rectangular wires, round and square wires have the advantage that relatively low directional forces are produced, since rectangular wires exert greater forces on account of their greater axial moment of inertia. It has been found that the exertion of rather lower directional forces is of advantage for the success of an orthodontic treatment for correcting the position of misaligned teeth, so that an improved position of the teeth can be achieved within a relatively short treatment time while the inconvenience for the patient is kept as little as possible.

In the case of bracket systems comprising only horizontally aligned slots, cross-sectionally rectangular archwires are usually used in the course of treatment. These are distinguished by an unsymmetrical exertion of force, i.e. directional forces of differing magnitude are exerted on the tooth by the archwire, depending on the direction in which it is bent. This makes it more difficult for directional forces to be exerted uniformly. By contrast with this, archwires of a square cross-section are preferably used in the case of the bracket system according to the invention. These are distinguished by the fact that they exert directional forces of the same magnitude on the tooth in the case of deflection in the occlusal-gingival direction as in the case of deflection in the labial-lingual direction, i.e. the exertion of force takes place in a symmetrical way in the case of square archwires when deflection or bending occurs. The uniform exertion of directional forces is facilitated as a result.

In order to simplify the insertion of the archwire into the side tooth bracket, it is advantageous if the slot opening of the side tooth bracket is adjoined, away from the slot base, by an insertion portion, which preferably widens in the occlusal direction. The insertion portion forms an adjusting aid for the insertion of the archwire into the slot.

In order to keep irritation of the tongue particularly low, it is advantageous if the side tooth bracket has a smooth surface on the lingual side.

In the case of a particularly preferred embodiment of the bracket system according to the invention, the side tooth bracket comprises a through-bore extending in the mesial-distal direction. This allows the control of rotation and the control of angulation in the side tooth region to be improved.

The following description of a preferred embodiment of the invention serves for a more detailed explanation in conjunction with the drawings.

### BRIEF DESCRIPTION OF THE SEVERAL VIEW OF THE DRAWINGS

FIG. 1 shows a schematic side view of a bracket according to the invention, which is secured to a front tooth of the upper jaw;

FIG. 2 shows a side view of the bracket from FIG. 1;

FIG. 3 shows a view of the bracket in the direction of the arrow A from FIG. 2;

FIG. 4 shows a sectional view along the line 4-4 in FIG. 3;

FIG. 5 shows a view corresponding to FIG. 3 of a bracket according to the invention for a canine tooth;

FIG. 6 shows a schematic side view of a side tooth bracket according to the invention, which is secured to a side tooth of the upper jaw;

FIG. 7 shows a side view of the side tooth bracket from FIG. 6;

FIG. 8 shows a perspective representation of the side tooth bracket from FIG. 6;

FIG. 9 shows a sectional view along the line 9-9 from FIG. 7; and

FIG. 10 shows a schematic representation of a bracket system according to the invention for all the teeth of the upper jaw and lower jaw.

### DETAILED DESCRIPTION OF THE INVENTION

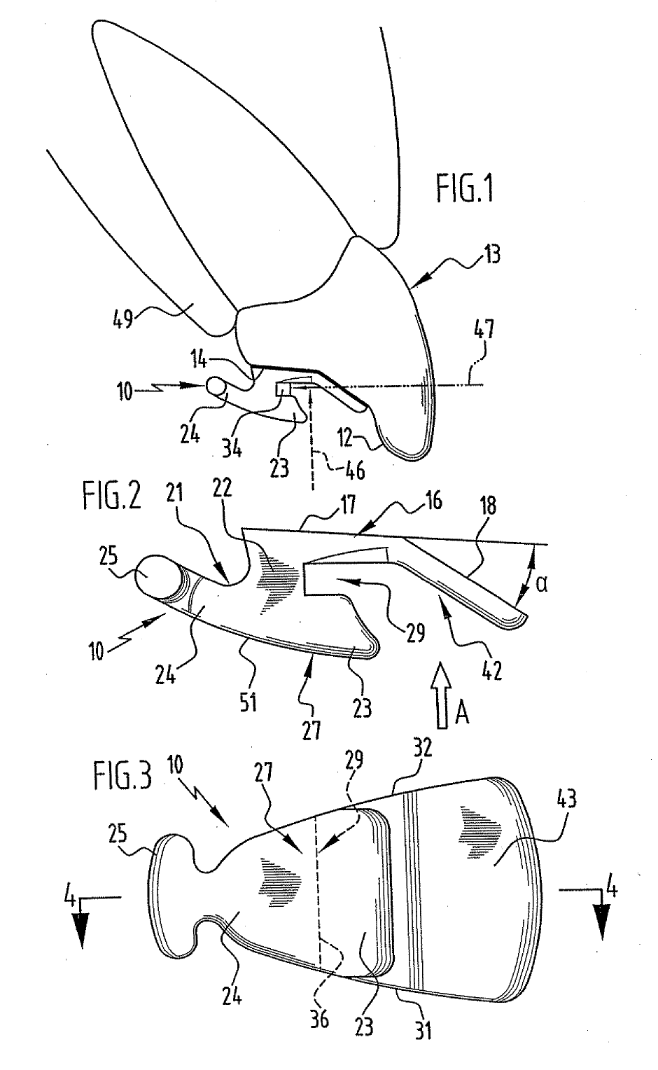

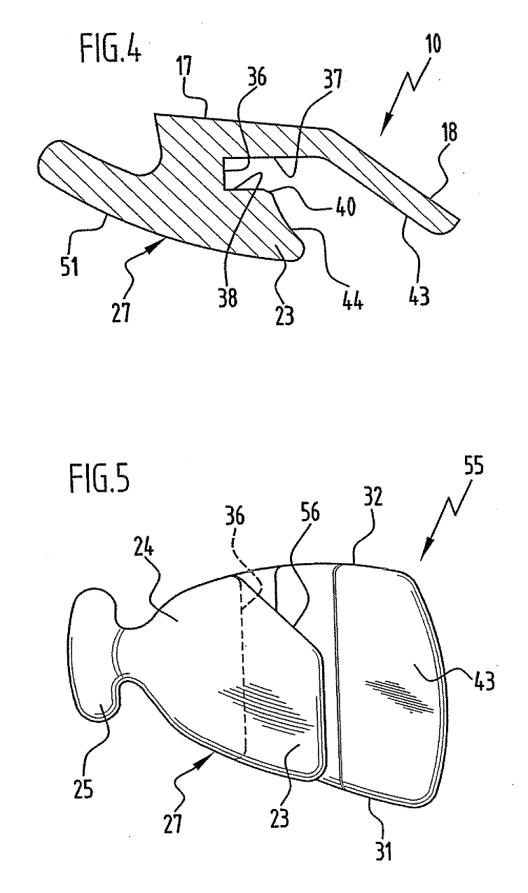

FIGS. 1 to 4 illustrate a bracket 10 according to the invention, which can be secured on the lingual side 12 of an upper jaw front tooth 13 by means of an adhesive 14. As revealed particularly clearly by FIGS. 2 and 4, the bracket 10 comprises a bracket base 16, which can be secured on the lingual side 12 and has a first abutting surface region 17 and a second abutting surface region 18, which are in each case of a planar configuration and are aligned at an angle a of approximately 30° in relation to one another. On the side away from the abutting surface region 17, the bracket base 16 is adjoined by a bracket body 21, which is of a substantially T-shaped configuration and has a web 22, which protrudes from the bracket base 16 on the occlusal side and the free end region of which is adjoined by a first wing 23, directed toward the second abutting surface region 18, and a second wing 24, directed away from said region. The second wing 24 carries at its free end a small T-shaped hook 25. The web 22 and the first wing 23 form a delimitation 27, which delimits a slot 29 in the lingual direction and in the occlusal direction. In the gingival direction, the slot 29 is delimited by the bracket base 16. The slot 29 extends from the mesial edge 31 to the distal edge 32 of the bracket 10 and serves for accommodating an archwire 34, with the aid of which directional forces can be exerted on the tooth 13 to correct a misaligned tooth.

The slot 29 has a slot base 36, which in the position of use of the bracket 10, as represented in FIG. 1, extends in the mesial-distal direction and is vertically aligned, from which there protrude two slot walls 37 and 38, which delimit between them at a distance from the slot base 36 a slot opening 40 and, in the position of use of the bracket 10, are aligned substantially horizontally, i.e. parallel to the occlusal plane. Away from the slot base 36, the slot opening 40 is adjoined by an insertion portion 42, which is delimited on the one hand by the rear side 43 of the bracket base 16, facing away from the second abutting surface is, and on the other hand by the front side 44 of the first wing 23, directed toward said surface, and widens in a V-shaped manner in the direction away from the slot base 36.

As FIG. 1 reveals particularly clearly, the archwire 34 can be inserted into the insertion portion 42 on the lingual side 12 of the tooth 13, at first from the occlusal side in the direction of the arrow 46 to the height of the slot opening 40, and subsequently it can be inserted in a horizontal direction, i.e. in the direction of the arrow 47, into the slot 29 until it butts against the slot base 36, in the position of use of the bracket 10 represented in FIG. 1. In this position, the archwire 34 is delimited by the bracket body 21 in the lingual direction and in the occlusal direction. The occlusal delimitation is achieved by means of the first wing 23 and the lingual delimitation is achieved by means of the web 22. In the gingival direction, the slot 40 is delimited by the bracket base 16. This not only makes possible particularly easy insertion of the archwire 34 into the slot 29 on the lingual side 12 of the tooth 13, but also has the effect of improving the control of forces of torsion and angulation exerted by the archwire 34 on the bracket 10 as a result of the slot 29 being enclosed in the gingival, lingual and occlusal directions.

The angled configuration of the two abutting surface regions 17 and 18 of the bracket base 16 makes it possible for the bracket 10 to be secured close to the gingiva 49, and consequently very close to the center of resistance of the tooth 1.3. Furthermore, the angular configuration of the abutting surface regions 17, 18 allows the thickness of the adhesive layer to be minimized.

The lingual side of the bracket 10, i.e. the rear side 51 of the bracket body 21 away from the bracket base 16, is of a level, convexly curved and smooth configuration, so that the tongue is hindered only slightly. Hindrance of the tongue by the small hook 25 can also be kept low, since it smoothly adjoins the rear side 5 1.

FIG. 5 schematically illustrates a bracket 55 according to the invention for a canine tooth. This differs from the bracket 10 described above with reference to FIGS. 1 to 4 only in that the distal edge 56 of the first wing 23 of the delimitation 27, extending from the slot base 36, is inclined in the direction of the mesial edge 3 1 of the bracket 5 5; apart from the angulation, the bracket 55 is otherwise configured in a manner virtually identical to that of the bracket 10; therefore, the same reference numerals as in FIGS. 1 to 4 are used in FIG. 5 for identical parts of the bracket 55. In this respect, to avoid repetition, reference is made to the statements made above.

The oblique alignment of the distal edge 56 of the delimitation 27 of the bracket 55 intended for securing to a canine tooth has the advantage that, even in the region between the canine tooth and the premolar directly adjacent to it, the archwire 34 can already be inserted into the slot 29 at an early time in orthodontic treatment, even if the canine tooth and the premolar are close together.

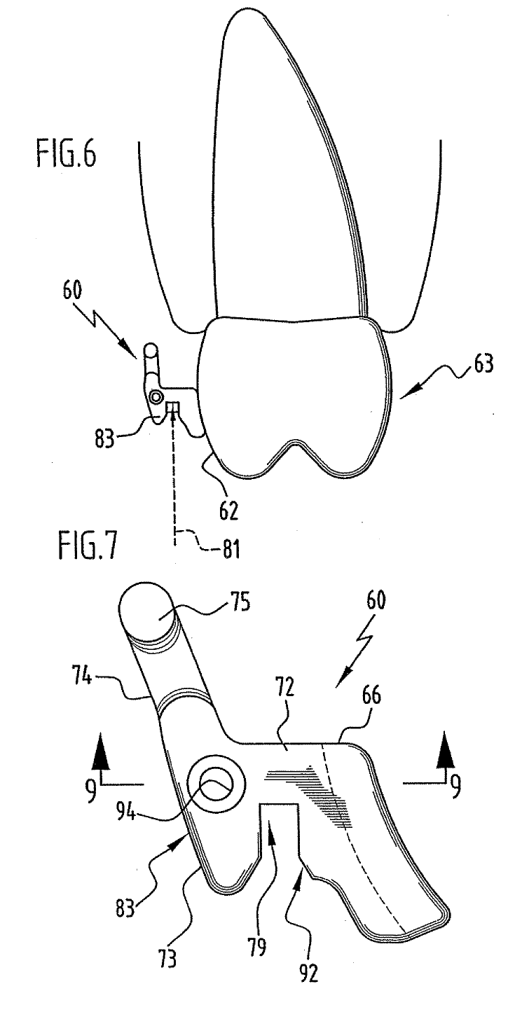

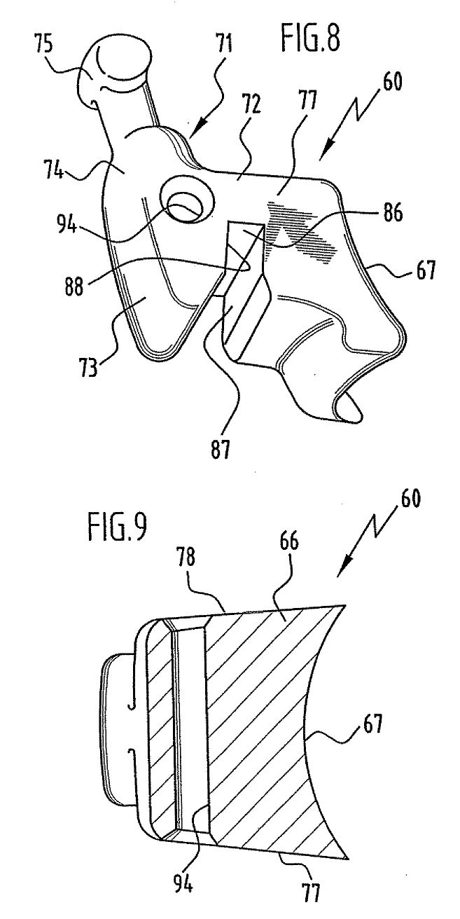

FIGS. 6 to 9 illustrate a bracket 60 according to the invention which can be secured on the lingual side 62 of an upper jaw side tooth 63. The side tooth bracket 60 has a bracket base 66, comprising an abutting surface 67 concavely curved in the mesial-distal direction. On the side away from the abutting surface 67, the bracket base 66 is adjoined by a bracket body 71, which is of a substantially T-shaped configuration and has a web 72, which protrudes from the bracket body 71 on the lingual side, as well as a first wing 73 and a second wing 74. The side tooth bracket 60 is illustrated in FIG. 6 in its position of use. In this position, the two wings 73 and 34 are aligned substantially vertically. The second wing 74 carries at its free end a small T-shaped hook 75, with the aid of which additional bracing means can be fixed to the side tooth bracket 60.

From the mesial edge 77 to the distal edge 78 of the side tooth bracket 60 there extends a cross-sectionally rectangular slot 79, which, in the position of use of the side tooth bracket 60, is directly accessible from the occlusal side, i.e. in the direction of the arrow 81 represented in FIG. 6, while it is delimited in the gingival direction by the web 72 and in the lingual direction by the first wing 73 of the bracket body 71. The web 72 and the first wing 73 consequently form a delimitation 83 of the slot 79 on the gingival and lingual sides. In the labial direction, the slot 79 is delimited by the bracket base 66.

The slot 79 comprises a slot base 86, which is horizontally aligned in the position of use of the side tooth bracket 60, and two slot walls 87, 88, which protrude from said base, in the position of use of the side tooth bracket 60 extend in the mesial-distal direction, are vertically aligned and are joined, away from the slot base 86, by an insertion portion 92, which extends in a V-shaped manner in the occlusal direction.

In the transitional region between the first wing 73 and the second wing 74, a through-bore 94 extending from the mesial edge 77 to the distal edge 78 is formed in the bracket body 71, allowing additional anchoring means to be secured to the side tooth bracket 60, in particular for better rotation control.

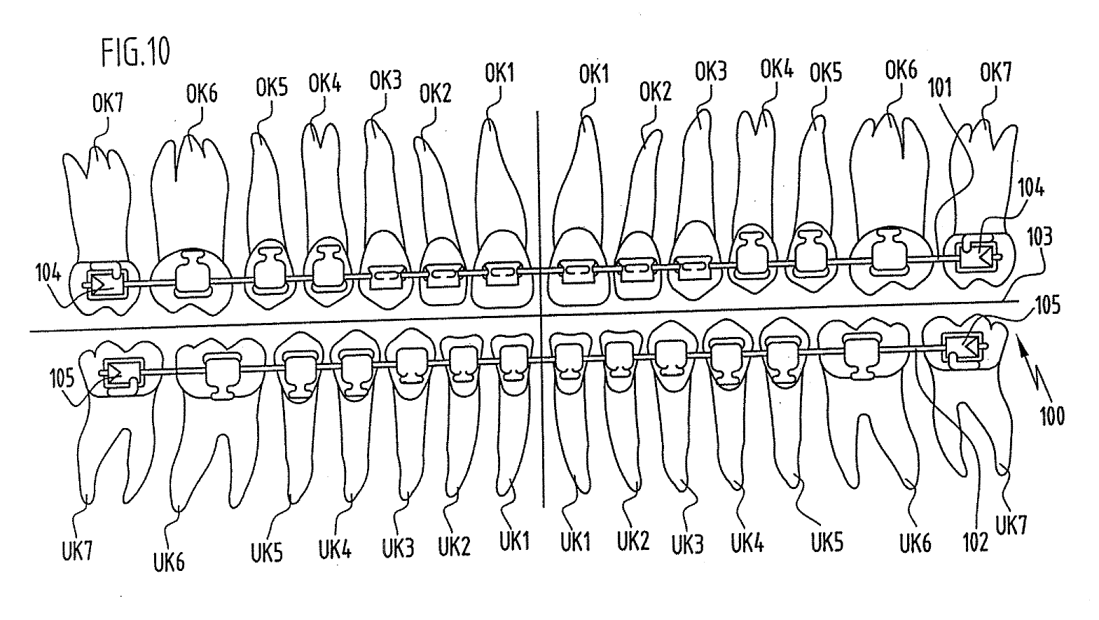

The use of side tooth bracket 60 in combination with front tooth and canine tooth brackets 10 and 55 has the advantage that treatment can be carried out with a square archwire cross-section and only a few differently formed brackets have to be used for correcting the position of misaligned teeth. For instance, it may be provided that a bracket system according to the invention for fixing archwires on all the teeth of the upper jaw and lower jaw in this example comprises only seven different brackets, buccal tubes 104, 105 additionally being used for securing the archwires to the rear buccal teeth. A bracket system of this type is schematically represented in FIG. 10 and provided overall with the reference numeral 100. Using this system, an upper jaw archwire 101 can be secured to the teeth of the upper jaw and a lower jaw archwire 102 can be secured to the teeth of the lower jaw, in each case on the lingual side. The two archwires 101 and 102 extend parallel to the occlusal plane 103. For securing the archwires 101 and 102 to the upper jaw front teeth OK1 and OK2, the brackets 10 explained above are used. Securing the upper jaw archwire 101 to the canine teeth OK3 takes place by means of the bracket 55, and securing the upperjaw archwire 103 to the side teeth OK4, OK5 and OK6 takes place by means of the side tooth brackets 60 described above. The upper jaw archwire 101 is secured to the upperjaw side teeth OK7 by means of a buccal tube 104, which is known per se and is therefore only schematically represented in the drawing.

The brackets 10 are used for securing the lower jaw archwire 102 for the front teeth UK1 and UK2 and for the lower jaw canine teeth UK3, and the securing of the lower jaw archwire 102 to the lower jaw side teeth UK4 to UK6 takes place by means of side tooth brackets 60. Buccal tubes 105, which are known per se to the person skilled in the art and are therefore not explained in any more detail here, are used for securing to the rear lower jaw side teeth UK7. The entire bracket system 100 in this example comprises only seven brackets formed differently in their torque and angulation angles. The brackets 10 for the right and left upper jaw front teeth OK1 and OK2 are of an identical configuration in this example, with a torque angle of 550 and an angulation angle of 0°; the side tooth brackets 60 for the right and left upper jaw teeth OK4 to OK6 have in each case a torque angle of 17° and an angulation angle of 0°. For the right and left upperjaw teeth OK3, canine teeth brackets 55 are used, these being mirror-symmetrical on account of the oblique configuration of the distal edge 56, but otherwise identically formed, with a torque angle of 55° and with an angulation angle of 12°. For the lower jaw teeth, the brackets 10 of the left front teeth UK1 to UK3 are of a configuration mirror-symmetrical to the brackets 10 of the right front teeth UK1 to UK3, differing only in their mirror-symmetrical alignment obliquely to the vertical, All the brackets 10 of the right and left lower jaw teeth UK1 to UK3 have in this example a torque angle of 40° and an angulation angle of 5°. The side tooth brackets 60 for the lower jaw side teeth UK4 to UK6 are identically configured, the torque angle and the angulation angle being 0°. Consequently, in the case of the bracket system 100 represented in FIG. 10, altogether only seven different brackets are used, with only three different torque angles for the upper jaw and only two different torque values for the lower jaw. Only the values of 0°, 5° and 12° are used for the angulation angle. It goes without saying that other torque and angulation angles can be used if required. An archwire 101, 102 can easily be inserted in all the brackets. The slots for the brackets of the front and canine teeth are horizontally aligned in the position of use, while the slots of the side tooth brackets are vertically aligned in the position of use, and force transfer from the archwires 101, 102 to the front and canine teeth is improved on account of the occlusal, gingival and lingual delimitation of the slots for the front and canine teeth.

1. A lingual bracket for correcting the position of teeth the lingual bracket comprising a lingual side, a gingival side, and an occlusal side, comprising a bracket base, which can be secured on the lingual side to a front or canine tooth, and comprising a bracket body, which protrudes from the bracket base, the bracket having a slot, which extends in a mesial-distal direction, delimited on the lingual side as well as on the gingival and occlusal sides, for accommodating an archwire, the slot being delimited on the gingival side by the bracket base and on the occlusal and lingual sides by the bracket body.

2. The bracket according to claim 1, wherein the bracket body has a web, which protrudes from the bracket base in an occlusal direction, and a free end, wherein the web carries at its free end a wing pointing in a labial direction, the web and the wing delimiting the slot on the lingual and occlusal sides, respectively, and the bracket base delimiting the slot on the gingival side.

3. The bracket according to claim 2, wherein an opening of the slot is adjoined, away from a slot base, by an insertion portion, which is delimited by the bracket base and by the bracket body.

4. The bracket according to claim 3, wherein the insertion portion is delimited by a front side of the wing directed away from the web and by a rear side of the bracket base.

5. The bracket according to claim 4, wherein the insertion portion widens in a direction away from the slot base.

6. The bracket according to claim 1, the bracket having a smooth, uninterrupted surface on the lingual side.

7. The bracket according to claim 1, the bracket being convexly or concavely curved on the lingual side.

8. The bracket according to claim 1, wherein a distal edge of a region of the bracket body delimiting the slot on the occlusal side is inclined in the direction of a mesial edge of the bracket.

9. The bracket according to claim 1, wherein the bracket base has, for butting against a tooth, abutting surface regions that are anatomically aligned at an angle in relation to one another.

10. The bracket according to claim 9, comprising a first abutting surface region and a second abutting surface region, wherein the first abutting surface region is inclined at an angle of approximately 10° to about 50° in relation to the second abutting surface region.

11. The bracket according to claim 9, wherein the abutting surface regions are in each case of a planar configuration.

12. A bracket system for fixing an archwire on the lingual sides of teeth, comprising one or more lingual brackets according to claim 1 for securing the archwire to the front and canine teeth, the bracket system comprising at least one side tooth bracket, comprising a bracket base, which can be fixed on the lingual side to a side tooth, and comprising a bracket body, which protrudes from the bracket base, the side tooth bracket having a slot, which extends in the mesial-distal direction for accommodating the archwire, comprising a slot base and two slot walls, which protrude from the base and delimit the slot on the gingival side as well as on the labial and lingual sides, and the archwire being insertable into the slot from the occlusal side.

13. The bracket system according to claim 12, wherein the slot walls are vertically aligned in the position of use of the side tooth bracket.

14. The bracket system according to claim 12, wherein the opening of the slot of the side tooth bracket is adjoined, away from the slot base, by an insertion portion.

15. The bracket system according to claim 12, wherein the side tooth bracket has a smooth surface on the lingual side.

16. The bracket system according to claim 12, wherein the side tooth bracket has a through-bore extending in the mesial-distal direction.
